(19) United States
(12) Patent Application Publication
(10) Pub. No.: US 2007/0071563 A1
(43) Pub. Date: Mar. 29, 2007

(54) Collapsible alignment guide for core bit

(76) Inventor: Darryl L. Snyder, Canton, OH (US)

Correspondence Address: Zollinger & Burleson, Ltd., P.O. Box 2368, North Canton, OH, 44720, US

(21) Appl. No.: 11/237,618

(22) Filed: Sep. 27, 2005

(51) Int. Cl. B23B 47/28

(52) U.S. Cl. 408/115 R

(57) ABSTRACT

An alignment guide for a core bit laterally supports a core bit perpendicular to the wall in which the hole is being drilled. The support thus allows the core bit to start a smooth hole perpendicular to the wall and successfully drill a high quality hole with smooth edges. In one configuration, the invention provides a collapsible alignment guide that is provided to the user in a collapsed configuration. The user erects the guide and uses a connector to hold the guide in an erect configuration wherein the guide may be used to stabilize a core bit. In one configuration, the guide may be formed from a flat blank of material that is folded into a collapsible six sided box with opposed sets of guide openings.

### BACKGROUND OF THE INVENTION

1. TECHNICAL FIELD

The present invention generally relates to tools and, more particularly, to an alignment guide for a core bit used with a rotary drilling apparatus. Specifically, the invention relates to a collapsible alignment guide that may be used with any of a plurality of different core bits to form smooth holes in block walls wherein the holes are desired to be perpendicular to the outer surface of the wall.

2. BACKGROUND INFORMATION

Numerous situations require a hole to be drilled through a block wall. One product that benefits from such a hole is the THERMOTHIMBLE® poke through disclosed in US 20050109523. A concrete core bit typically is used to form these holes in block walls. A concrete core bit is an elongated cylindrical drill bit with a circle of teeth disposed on the cutting end of the cylinder. A drawback with using these bits for cut holes in concrete block walls is that there is no centering mechanism or starter on the bit itself. The combination of the wall material and the difficulty of maintaining the core bits centered makes forming smooth holes in block walls difficult to form.

### BRIEF SUMMARY OF THE INVENTION

The invention provides an alignment guide for a core bit. The guide laterally supports a core bit perpendicular to the wall in which the hole is being drilled. The support thus allows the core bit to start a smooth hole perpendicular to the wall and successfully drill a high quality hole with smooth edges.

In one configuration, the invention provides a collapsible alignment guide for a core bit. The guide is provided to the user in a collapsed configuration. The user erects the guide and uses a connector to hold the guide in an erect configuration wherein the guide may be used to stabilize a core bit. In one configuration, the guide may be formed from a flat blank of material that is folded into a collapsible six sided box with opposed sets of guide openings.

In another configuration, the alignment guide is arranged to work with a plurality of different core bit diameters. Different hole sizes are provided on the three sets of opposed walls of a six-sided box. Perforated lines may be provided outwardly of the openings to allow the user to increase the size of the openings to configure the guide for a different size bit.

The invention also provides a configuration wherein the small core bit holes are formed through double thickness walls formed by overlap tabs.

### BRIEF DESCRIPTION OF THE SEVERAL VIEWS OF THE DRAWINGS

FIG. 1 is a top plan view of the alignment guide in a collapsed configuration.

FIG. 2 is a perspective view of FIG. 1.

FIG. 3 is a perspective view of the alignment guide in an erected configuration.

FIG. 4 is a perspective view of the alignment guide being used to laterally support a core bit while the core bit is used to form a hole in a concrete block wall.

FIG. 5 is a top plan view of a blank used to form the guide.

FIG. 6 is a top plan view of a blank used to form a different configuration of the guide.

FIG. 7 is a side view of a guide being used on a wall.

FIG. 8 is a front view of a guide with handles that are used to help hold the guide in place.

Similar numbers refer to similar parts throughout the specification.

### DETAILED DESCRIPTION OF THE INVENTION

The guide of the invention is indicated generally by the numeral 2 in the accompanying drawings. Guide 2 is used to stabilize and laterally support a core bit 4 during the process of drilling a hole in a structure such as a concrete block wall 6 or foundation 6. Such stabilization and lateral support of a core bit 4 has been found to yield smooth, well-defined holes in traditionally unpredictable surfaces such as concrete block structures.

Guide 2 is in the form of a six-sided box having guide openings disposed on opposed walls of the box. The pairs of opposed walls are disposed perpendicular to one another when the box is erected and ready for use. Guide 2 provides at least one pair of aligned guide openings configured to be slightly larger than the outer diameter of core bit 4. The openings a small enough to create some friction with a rotating core bit but large enough to allow the bit to be easily slid through the openings. Guide 2 may provide three sets of aligned guide openings on its three sets of opposed walls for three different diameter bits. The three sets of openings may be provided in small, medium, and large diameters. Guide 2 may also provide additional alternative guide opening sizes to increase its versatility with different bit diameters.

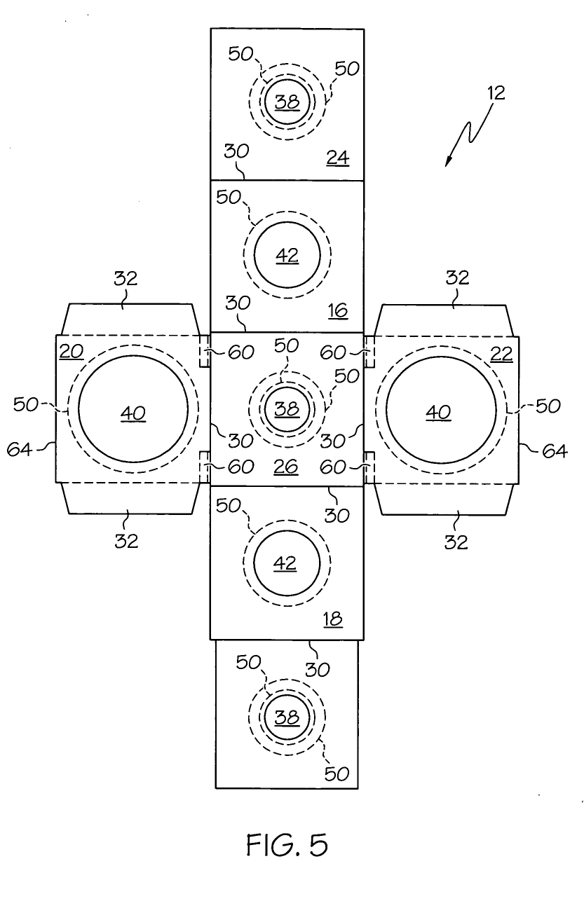

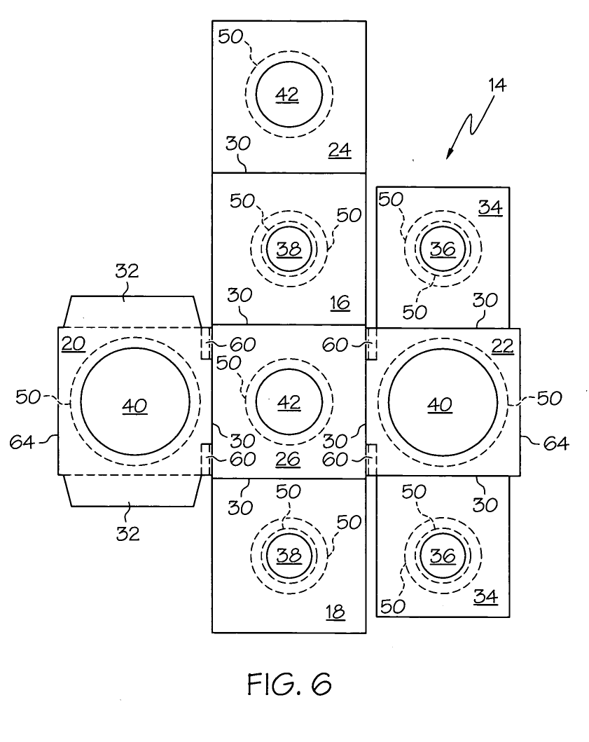

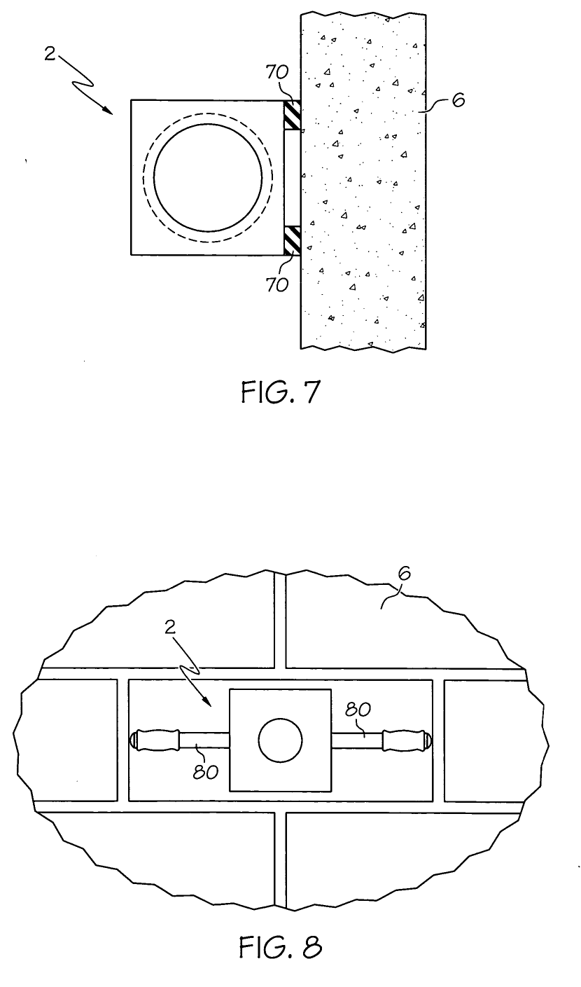

Guide 2 may be formed from a unitary blank 12 or 14 as shown in FIGS. 5 and 6 that defines front 16, back 18, left 20, right 22, top 24, and bottom 26 walls connected together with living hinges 30. In some materials, the material of blank 12 or 14 may be scored to form the living hinges and to allow them to function. Such scoring is particularly useful when blank 12 or 14 is fabricated from a material having a pair of spaced material layers such as those found in corrugated materials (paper or polymer) or a thicker material that has a memory when folded. In addition to the walls identified above, blank 12 and 14 also may include optional tabs 32 that may be used to erect blank 12 or 14 from a flat blank into guide 2. Connectors such as staples, rivets, tape, and/or adhesives may be used with tabs 32 to hold blanks 12 and 14 in their assembled configurations. Tabs 32 extend from walls 20 and 22 so that tabs 32 will be disposed against walls 16 and 18 which have the smaller diameter openings 38, 42. This configuration allows tabs 32 to be relatively large (up to ¼ of the width of walls 24 and 26) to provide stability to guide 2 while not interfering with openings 38, 42.

FIG. 5 shows one alternative configuration with a large tab extending from the top edge (the edge disposed against top wall 24 when guide 2 is erected) that defines an opening 38 disposed to align with opening 38 in wall 24. This tab configuration is optional. This tab may be the same size as tabs 32.

In the alternative configuration shown in FIG. 6, overlap tabs 34 define openings 36 that are sized and positioned to be aligned with openings 38 defined by walls 16 and 18. Although overlap tabs 34 may be used with any opening set on guide 2, the exemplary embodiment of FIG. 6 uses overlap tabs 34 with openings 36 and 38 because opening sets 36 and 38 have the smallest diameters which provide the least amount of surface area for spreading the heat generated when core bit 4 is being used. Overlap tabs 34 are thus used to double the thickness of the wall material to help guide 2 stand up to use with a small diameter core bit.

In the blank of FIG. 5, each opposed wall set 16-18, 20-22, and 24-26 has an opening set 42, 40, and 38, respectively, configured for different-sized core bits. Each opposed wall set may have an opening adjustable for at least two different diameter core bits. This adjustability is provided by defining a larger opening with a perforated line 50 outside the smaller opening. When the user wants to configure guide 2 for a bit size that is not already defined, the user may remove the ring of material surrounding the opening to increase the diameter of the opening. This system allows guide 2 to be used with at least six different diameter core bits. As shown in the drawings, additional perforated rings may be provided for additional diameter core bits.

Notches 60 may be used to reduce the resiliency or spring-back force of the hinge between walls 20/22 and 26. Notches 60 may be enlarged scored areas or sections of walls 20 and 22 that have been completely removed. Both methods reduce the width and thus the strength of the living hinge and allow walls 20 and 22 to be easily folded into the erected position.

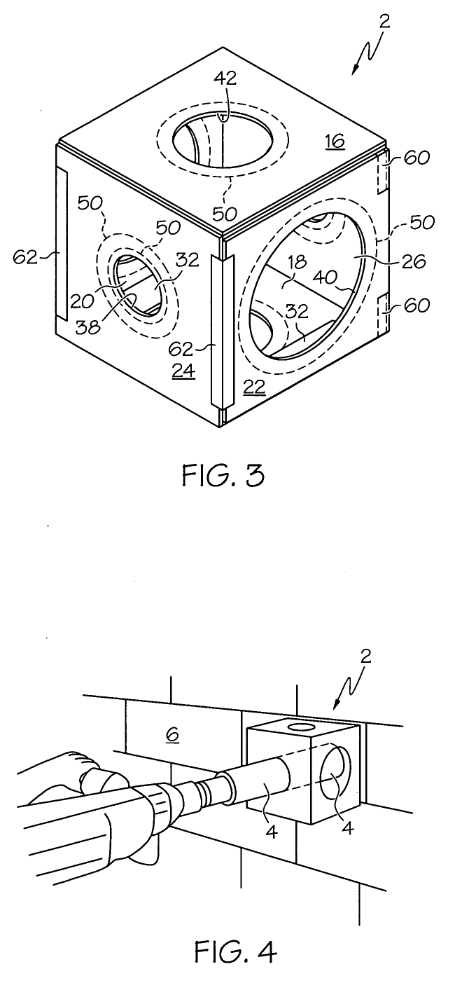

Tape 62 may be used to hold walls 20 and 22 in the erected position as shown in FIG. 3. In an alternative embodiment, additional tabs 32 may extend from end walls 64. These additional tabs would be folded inside the walls and secured with fasteners.

Three or four mounting pads 70 may be used when guide is in use. Pads 70 may have adhesive holding forces that help hold guide 2 in place. Pads 70 may be adhesively connected to guide 2 and wall 6. In an alternative, pads 70 may be provided in pairs of hook and loop connectors that are held to guide 2 and wall 6 with adhesive and then locked together with the hook and loop connectors. An example of this type of product is available as Command Removable Interlocking Fasteners sold by 3M. A mounting putty may also be used to help hold guide 2 in place during use. Pads 70 may be used to dampen vibration forces.

At least one handle 80 also may be used to allow the user to hold guide 2 in place during use. Handles 80 may be secured to guide 2 with connectors such as adhesives, tapes, interlocking engagements, and mechanical connectors.

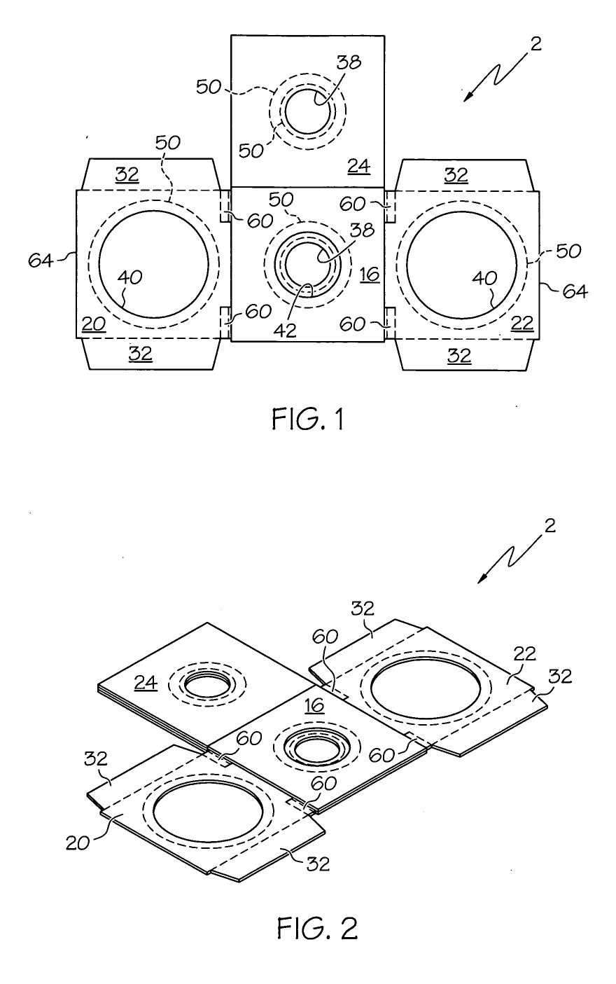

Guide 2 is formed in the configuration shown in FIGS. 5 and 6. Guide 2 may be shipped to the customer in this flat configuration of FIGS. 5 and 6. In the alternative, guide 2 may be fastened together and shipped to the user in the collapsed configuration shown in FIGS. 1 and 2. The user then erects guide 2 and fastens tabs 32 into place. Tape 62 may be used to secure any loose edges. Pads 70 may then be added if they are desired. The user then aligns guide 2 with the location on wall 6 where the hole is to be formed. The user then inserts core bit 4 through the appropriate openings on guide 2 and starts drilling. Drilling a vertical wall surface with a core bit usually requires two hands to hold the drill. A second person may be required to hold guide 2 in place when guide 2 is not secured to wall 6 with a connector. While the user is drilling the hole, guide 2 provides lateral support to the core bit and helps prevent the bit from wandering or becoming non-perpendicular to wall 6. The use of guide 2 with a core bit has been found to yield smooth, well defined holes in concrete block walls.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method for forming a hole in a concrete block wall with a core bit and a guide, the core bit having a diameter; the method comprising the steps of:
(a) providing an erectable guide in a substantially flat, collapsed configuration;
(b) erecting the guide into the form of a six-sided box having three pairs of opposed sides; at least one of the opposed sides defining a pair of opposed guide openings that are slightly larger than the diameter of the core bit;
(c) selecting a location on the concrete wall for the hole to be formed with the core bit;
(d) aligning the erected guide with the location selected in step (c);
(e) inserting the core bit into the opposed guide openings; and
(f) drilling the hole in the concrete block wall at the selected location while laterally supporting the core bit with the guide.

2. The method of claim 1, further comprising the step of securing the erected guide to the wall with a connector such that the guide openings are aligned with the location selected in step (c).

3. The method of claim 1, wherein the guide includes a plurality of walls connected together with living hinges and at least a pair of overlap tabs extending from one of the walls, each of the overlap tabs defining an opening the same size as the pair of opposed guide openings; the method further comprising the step of:
folding the overlap tabs to align the openings of the overlap tabs with the opposed guide openings.

4. A collapsible guide for a core bit; the collapsible guide comprising:
a six-sided box configurable from a substantially flat collapsed position to an erected position; the six-sided box having first, second, and third pairs of opposed walls when in the erected position; the wall pairs being disposed in reference planes disposed perpendicular to one another;
the first pair of opposed walls defining a first pair of opposed guide openings having a first diameter;
the second pair of opposed walls defining a second pair of opposed guide openings having a second diameter;
the third pair of opposed walls defining a third pair of opposed guide openings having a third diameter;
each pair of opposed guide openings having two coaxially-disposed openings; and
the first diameter being smaller than the second diameter and the second diameter being smaller than the third diameter.

5. The guide of claim 4, wherein each of the walls defines a perforated guide opening line disposed concentric with the guide opening defined by the wall; the perforated guide opening line adapted to allow the user to remove a ring-shaped section of the wall in increase the diameter of the guide opening.

6. The guide of claim 5, wherein two of the opposed walls define a second perforated guide opening line disposed concentric with the guide opening defined by the wall; the perforated guide opening line adapted to allow the user to remove a ring-shaped section of the wall in increase the diameter of the guide opening.

7. The guide of claim 4, wherein the box is formed from a flat blank having a front wall, a back wall, a right wall, a left wall, a top wall, and a bottom wall; and
the front wall having upper and lower edges; the upper edge of the front wall connected to a front edge of the top wall; the bottom edge of the front wall connected to a front edge of the bottom wall;
a rear edge of the bottom wall connected to the bottom edge of the rear wall; an upper edge of the rear wall connected to a first tab; the first tab adapted to be connected to the top wall when the blank is assembled into the guide;
the left wall connected to the left edge of the bottom wall; and
the right wall connected to the right edge of the bottom wall.

8. The guide of claim 7, further comprising attachments tabs connected to the left and right walls; the left and right walls defining the guide opening with the third diameter.

9. The guide of claim 4, further comprising a first overlap tab connected to one of the walls; the first overlap tab being disposed against one of the walls; the first overlap tab defining a guide opening that matches the diameter of the guide opening defined by the wall overlapped by the first overlap tab.

10. The guide of claim 9, further comprising a second overlap tab connected to one of the walls; the second overlap tab being disposed against the wall opposed to the wall overlapped by the first overlap tab; the second overlap tab defining a guide opening that matches the diameter of the guide opening defined by the wall overlapped by the second overlap tab.

11. The guide of claim 4, wherein the box is fabricated from a corrugated material.

12. The guide of claim 4, further comprising at least one handle connected to the side of the erected box; the handle extending away from the box.

13. The guide of claim 4, further comprising at least three mounting pads attached to one of the walls of the box.

14. A collapsible guide for a core bit; the collapsible guide comprising:
a six-sided box configurable from a substantially flat collapsed position to an erected position; the six-sided box having first, second, and third pairs of opposed walls when in the erected position; and
at least one pair of opposed walls defining a pair of coaxially-disposed, opposed guide openings; the guide openings having a first diameter.

15. The guide of claim 14, wherein each of the walls defining a guide opening also defines a perforated guide opening line disposed concentric with the guide opening; the perforated guide opening line adapted to allow the user to remove a ring-shaped section of the wall in increase the diameter of the guide opening.

16. The guide of claim 15, further comprising a first overlap tab connected to one of the walls; the first overlap tab being disposed against one of the walls that defines a guide opening; the first overlap tab defining a guide opening that matches the diameter of the guide opening defined by the wall overlapped by the first overlap tab.
